(19) United States
(12) Patent Application Publication
(10) Pub. No.: US 2026/0127671 A1
(43) Pub. Date: May 7, 2026

(54) SYSTEMS AND METHODS FOR MARKET ANALYSIS

(71) Applicant: Yurek Vazquez, Miami, FL (US)

(72) Inventor: Yurek Vazquez, Miami, FL (US)

(21) Appl. No.: 18/935,424

(22) Filed: Nov. 1, 2024

Related U.S. Application Data
(60) Provisional application No. 63/536,246, filed on Sep. 1, 2023.

(51) Int. Cl. G06Q 40/06

(52) U.S. Cl. CPC G06Q 40/06

(57) ABSTRACT

A system for automating financial due diligence processes for a real estate property is disclosed, including at least one user computing device in operable connection with a user network. An application server is in operable communication with the user network to host an application program for enabling the automation of financial due diligence for a real estate property. An advanced search engine searches a property listing database and displays a plurality of properties meeting at least one input related to a financial data metric. An assumption module receives a plurality of assumptions from a real estate property listing and a plurality of real estate data. A financial modelling module generates a plurality of models using the plurality of assumptions. A scoring and analysis module calculates a score associated with the real estate property which is displayed on a property listing interface to indicate a potential value of the real estate property.

### CROSS-REFERENE TO RELATED APPLICATIONS

The present application claims priority to U.S. Provisional Application No. 63/536,246 filed Sep. 1, 2023, titled “MARKET ANALYSIS SYSTEM,” which is hereby incorporated by reference in its entirety.

### TECHNICAL FIELD

The embodiments disclosed herein generally relate to analysis and prediction of markets, and more particularly relate to automated prediction and centralization of market information via amalgamation and correlation of market data.

### BACKGROUND

Despite the currently available trading tools, traders often have to spend significant amounts of time learning how to use one or more trading tools. Furthermore, trading tools are not customized for users to quickly engage in either trading or learning about markets and trading, as they need to be customized by the user. Even when the tool is customized by a user, the user still needs to engage with the tool to find information, make assessments, and otherwise engage in all typical activities that involve trading. Often, the information needed by the trader is accessible only outside of the trading tool platform. As time goes on, and the more trades that are made, the higher the chance of mistakes in trading (including failing to trade when an opportunity presents itself) due to human error and decision fatigue.

There is a need in the market for a trading tool that consolidates information about one or more markets and/or one or more commodities and immediately informs and/or educates traders, without user intervention, about the market without the need of tool customization.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a market analysis system including a memory to store information associated with a user, wherein the stored information includes market data. A process executes instructions stored in the memory, wherein the processor is operable to analyze market data which is available for analysis without intervention from the user. Based on the analysis of the market data, the processor determines a market strength and an asset strength. Based on the market and asset strength, the processor determines longs and shorts within the market and generates a dashboard displaying on a screen the market strength, asset strength, the longs, and the shorts.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a market analysis system includes a computer or computing device operating an application. The application has three components or modules: first, a dashboard; second, a fully automated prediction tool that autonomously and without user intervention analyzes market conditions and determines or predicts trends in the market; and third, a user experience module.

The dashboard centralizes and displays information from one or more markets (for example, all-major-markets). In some embodiments, the dashboard centralizes and displays information from the correlation among two or more markets The prediction tool, autonomously and without user intervention, analyzes market conditions and correlations to determine or predict trends in the market or markets.

The user experience module includes a data visualization submodule, education submodule, a community submodule, and a profit-sharing submodule. The data visualization submodule enables the display of data and graphics related to market data or one or more markets.

The community submodule connects and weights trading ideas from groups of users.

The education submodule includes courses and learning content for users.

The profit-sharing submodule enables outreach from groups of users to other users and non-users.

In one general aspect, market analysis system may include a memory to store information associated with a user, where the stored information includes market data. Market analysis system may also include a processor to execute instructions stored in memory, where the processor is operable to: analyze the market data, where the market data is available for analysis without intervention from the user; based on the analysis of the market data, determine a market strength and a commodity strength; based on the market strength and the commodity strength, determine longs and shorts; and generate a dashboard displaying on a screen the market strength, the commodity strength, the longs, and the shorts. Other embodiments of this aspect include corresponding computer systems, apparatus, and computer programs recorded on one or more computer storage devices, each configured to perform the actions of the methods.

Implementations may include one or more of the following features. Market analysis system where the commodity strength is a currency strength. Implementations of the described techniques may include hardware, a method or process, or a computer tangible medium.

In one general aspect, automated market analysis method may include analyzing market data, where the market data is available without intervention from the user. Automated market analysis method may also include determining market conditions based on the market data. Method may furthermore include based on the market conditions, determine a market strength and a commodity strength. Method may in addition include based on the market strength and the commodity strength, determine longs and shorts. Method may moreover include generating a dashboard displaying on a screen the market strength, the commodity strength, the longs, and the shorts. Other embodiments of this aspect include corresponding computer systems, apparatus, and computer programs recorded on one or more computer storage devices, each configured to perform the actions of the methods.

Implementations may include one or more of the following features. Market analysis system where the commodity strength is a currency strength. Implementations of the described techniques may include hardware, a method or process, or a computer tangible medium.

In one general aspect, non-transitory computer-readable medium may include one or more instructions that, when executed by one or more processors of a device, cause the device to: analyze market data, where the market data is available without intervention from the user; determine market conditions based on the market data; based on the market conditions, determine a market strength and a commodity strength; based on the market strength and the commodity strength, determine longs and shorts; generate a dashboard displaying on a screen the market strength, the commodity strength, the longs, and the shorts. Other embodiments of this aspect include corresponding computer systems, apparatus, and computer programs recorded on one or more computer storage devices, each configured to perform the actions of the methods.

Implementations may include one or more of the following features. Non-transitory computer-readable medium where the commodity strength is a currency strength. Implementations of the described techniques may include hardware, a method or process, or a computer tangible medium.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2A illustrates a block diagram of the application program, according to some embodiments;

FIG. 2B illustrates a screenshot of a computing device displaying a dashboard, according to some embodiments;

FIG. 2C illustrates an asset price chart showing price predictions, according to some embodiments;

FIG. 2D illustrates a block diagram of the user experience module, according to some embodiments;

FIG. 3 illustrates a block diagram of a prediction tool receiving market data from data sources, according to some embodiments; and

FIG. 4 illustrates a process for generating a centralized market data dashboard, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to systems and method for predicting market trends and providing automated market analysis. The system includes a data visualization submodule for displaying market data on the display of a computing device to enable the user to view various market metrics, trends, etc. This is accomplished through the use of a prediction tool which applies a trading algorithm to autonomously analyze the market data.

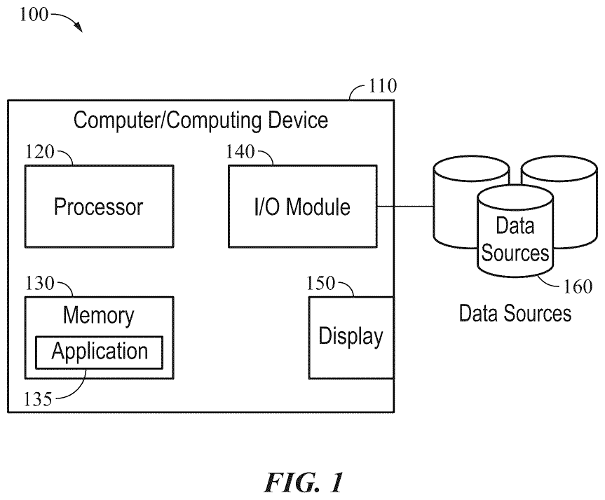

FIG. 1 illustrates market analysis system 100. according to one or more aspects. Various features described within FIG. 1 may generally complement the description of the other figures of the present disclosure. The market analysis system 100 includes a computer 110, which includes a processor 120, a memory 130 including an application 135, an input/output module (or “I/O module”) 140 connected directly or through a network (not shown) to data sources 160, and a display 150.

The processor 120 is wired and/or wirelessly connected to and/or communicatively connected to the memory 130 and the I/O module 140. The I/O module 140 is wired and/or wirelessly connected to and/or communicatively connected to the display 150 and the network and/or to the data sources 160. A computing device such as the computer 110 can be or be embedded in another device, e.g., a mobile telephone, a smartphone, a tablet, a laptop, server, desktop computer, a personal digital assistant (PDA), a portable storage device (e.g., a universal serial bus (USB) flash drive), and/or the like. Likewise, a general computer or computing device may become a market analysis system 100 via the execution of an application such as the application 135.

The processor 120 includes any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor 120 may be any technically feasible hardware unit capable of processing data and/or executing software applications such as the application 135. Further, in the context of this disclosure, the computing elements shown in the computer 110 may correspond to a physical computing system (e.g., a local or networked computing device) or may be a virtual computing instance executing within a computing cloud.

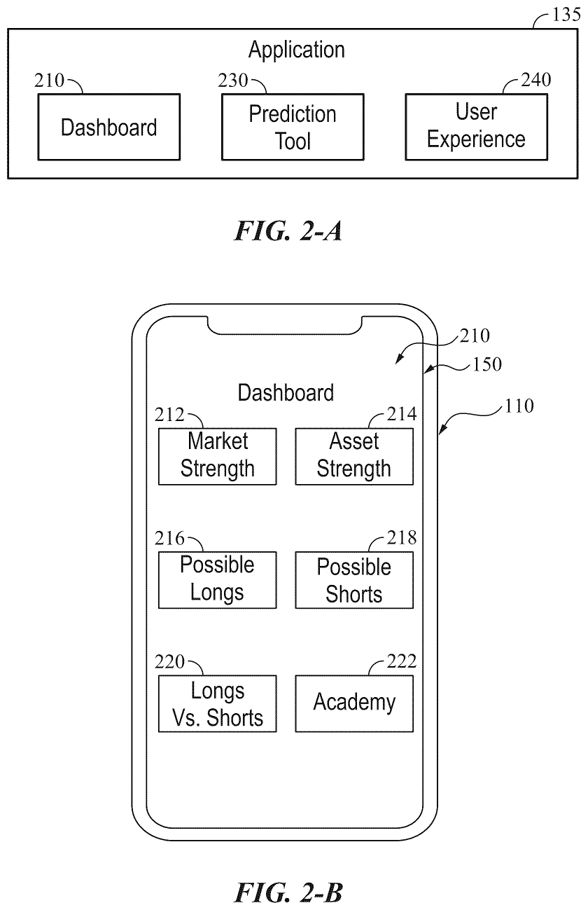

Memory 130 includes a random-access memory (RAM) module, a read-only memory (ROM) module, a flash memory unit, a hard disk, magnetic disks, optical disks, magneto-optical disks, a mass storage device, a database, and/or any other type of memory unit or combination thereof. Processor 120 and I/O module 140 are configured to read instructions and/or data from and write instructions and/or data to memory 130 and/or the data sources 160. Memory 130 stores various software programs that can be executed by processor(s) 120 and application data associated with said software programs, including software that runs methods, steps, and processes such as the software, methods, steps, and/or processes described in this disclosure. The various software programs and the associated application data include the application 135. The application 135 is configured to implement aspects described herein. The memory 130 and the data sources 160 store data accessible by the application 135. According to one or more aspects, the application 135 may include software elements corresponding to one or more of the various aspects described herein. For example, application 135 may be implemented in various aspects using any desired programming language, scripting language, or combination of programming languages and/or scripting languages (e.g., C, C++, C #, PYTHON®, JAVA®, JAVASCRIPT®, PERL®, and/or the like). Furthermore, the code, instructions, data, functionality, and/or results from processing and/or execution of the application 135 can vary according to the person or use of the system, the data available, the device and/or user running the application (for example, the application 135 in a server, an administrator computer, a staff/employee computer, and a client or user computer), the role of the user and/or the device (for example, the user of a computer running the application 135 as an administrator then switching and using the computer running the application 135 as a client), and/or the like. Therefore, the application 135 may have aspects that operate in different computers that may or may not be connected to each other and/or to the same network(s). Aspects of the application 135 are further described in the description of FIGS. 2-4, below.

The I/O module 140 provides the hardware, firmware, and/or software for the computer 110 to interact with other components and devices, including the data sources 160, the display 150, the network, other devices connected to the network, and/or the like. According to one or more aspects, the I/O module 140 can be connected to other devices, either wired or wirelessly, including input peripherals such as keyboards, microphones, cameras, and/or the like. According to one or more aspects, the I/O module 140, automatically and/or manually via user input through the display 150 and/or via the network, request, obtain, get, post, put, create, read, update, and/or delete any information and/or data from other computers and/or devices connected to the network. The processor 120, through the I/O module 140, actuates, creates, generates, sends, and/or receives signals and/or data to and/or from the network and/or the display 150. The I/O module 140 is configured to allow data to be exchanged between the computer 110 and other devices attached to a network, such as other computer systems, cloud services, remote databases, and/or the like. According to one or more aspects, the I/O module 140 supports communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol, including WAN, LAN, Wi-Fi®, Bluetooth®, and/or the like.

Cloud services are any networked, online, internet, and/or web services that may be implemented or used to perform as or embody part or all of the computer 110 and/or to execute part or all of the application 135, handle and/or store the data accessed by the application 135, via provisioning software, Software-as-a-Service (SaaS), platform, Platform-as-a-Service (PaaS), infrastructure, Infrastructure-as-a-Service (IaaS), artificial intelligence models and/or processing, Artificial Intelligence-as-a-Service (AIaaS), and/or other technologies, such as Amazon Web Services (AWS®), Microsoft® Azure®, Google Cloud Platform (GCP®), Snowflake®, Heroku®, Netlify®, DigitalOcean®, IBM® Cloud, Oracle® Cloud Infrastructure, and/or the like.

The display 150 includes devices capable of providing input, such as a touchscreen, touch sensitive display, keyboard, a mouse, a smart pen, a camera, buttons, a microphone, a headphone, a headset, photosensors, biosensors, haptic sensors, and so forth, as well as devices capable of providing output, such as a display device, a touchscreen, a touch sensitive display, a speaker, headphone, a headset, touchscreen, haptic transducer, LEDs, and so forth. Additionally, the display 150 may include devices capable of both receiving input and providing output, such as a touchscreen, a touch sensitive display, haptic devices, a universal serial bus (USB) port, and so forth. The interface 135 may be configured to receive various types of input from a user, such as verbal commands, typed input, gestures, sounds, and so forth, and to also provide various types of output to the user, such as displayed digital images, digital videos, sound, text, alarms, reminders, haptic sensations, and so forth. According to one or more aspects, the display 150 (or part of the display 150) is embedded and/or integrated with the computer 110. For example, the computer 110 may have the display 150 on the housing that encloses the computer 105. According to one or more aspects, the display 150 (or part of the display 150) is separate from (is not embedded and/or integrated with) the computer 110. For example, the computer 110 may have the display 150 separate from the housing that encloses the computer 110, while connected wirelessly to the computer 110 via Bluetooth® or another wireless protocol.

The computer 110 and/or the data sources 160 may be local, remote, cloud-based, implemented via cloud services, shared, dedicated, and/or the like. The data sources 160 includes a computer, a database, a data warehouse, a data lake, a data repository, a file storage, RAM, ROM, flash memory, and/or the like. The data sources 160 can be or include any database technologies and/or any database management system (DBMS), including hierarchical, network, relational, object-oriented, sql, no-sql, graph, ER model, and/or document databases and/or DBMSs, and/or the like. Throughout the description of the various aspects, it should be understood that the memory 120 and/or the data sources 160 store and allow reading, writing, editing, and/or deleting of any data, values, information, parameters, and/or the like, for the operation of the computer 110, application 135, and/or the market analysis system 100. According to one or more aspects, the data sources 160 is a plurality of databases. According to one or more aspects, the data sources 160 is implemented or resides partially or completely inside of the computer 110 and/or are accessible to the computer 110 and/or the application 135 via the network.

The network includes any technically feasible type of communications network that allows data to be exchanged between the computer 110 and external entities or devices. For example, network may include a wide area network (WAN), a local area network (LAN), a wireless (Wi-Fi®) network, Bluetooth®, and/or the Internet, among others (including any communication channel, medium, and/or network accessible by the I/O module 140). According to one or more aspects, the I/O module 140 is not directly connected to one or more elements, parts, components, devices and/or networks. According to one or more aspects, the I/O module 140 connects wired and/or wirelessly to the to one or more elements, parts, components, devices and/or networks through the network.

Also, any connection may be associated with a computer-readable medium or media. For example, the application 135 and/or data associated with or operated by the application 135 may be transmitted from or through a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave, all of which are included in the definition of medium. Storage of any kind data of the application 135 and/or data associated with or operated by the application 135 such as hard discs, disks, RAM, ROM, flash memory, cloud storage, and/or the like (including the memory 130 and/or the data sources 160) is also included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

The data sources 160 include one or more databases or electronic sources of market data. Market data is any data, whether historic data, real-time data, delayed data, stored data, and/or the like, about one or more markets or aspects of assets including commodities and/or securities and/or currencies (hereinafter “assets”) in such markets. Thus, market data may include price information, time and date information related to pricing, historical pricing information, and any other data that is used or may be used by traders of assets for making trading decisions.

FIGS. 2-A through 2-D illustrate various aspects of the application 135, according to one or more aspects. FIG. 2-A illustrates a block diagram of the various components or modules of the application 135, including a dashboard 210, a prediction tool module 230, and a user experience module 240, according to one or more aspects.

FIG. 2-B illustrates the dashboard 210 as it would appear on a display 150, according to one or more aspects. The dashboard 210 centralizes and displays information from one or more markets (for example, all major markets) in a market strength tab 212. This information centralization includes the application of a trading algorithm to market data from the one or more markets. Market strength for a particular market is determined based on the application of the trading algorithm to the market data from the respective market, or from the application of the trading algorithm among market data from two or more markets.

In some embodiments, the dashboard 210 centralizes and displays information from the correlation among two or more markets. This information centralization includes the application of the trading algorithm to market data and/or correlation among the two or more markets via the application of trading algorithms.

In some embodiments, the market strength tab 212 displays whether the one or more markets are risk-on or risk-off markets.

Asset strength is indicated at an asset strength tab 214 in the display 210. Asset strength is determined based on the application of the trading algorithm to the market data. Asset strength indicates the likelihood that an asset increases in value. In some embodiments, the asset strength is a currency strength, such that the asset strength tab 214 is a currency strength tab.

The prediction tool, using the trading algorithm, determines possible longs and possible shorts based on the market strength and/or the asset strength. Possible longs are identified at the possible longs tab 216. Possible shorts are identified at the possible shorts tab 218. In one or more embodiments, the possible longs tab 216 and/or the possible shorts tab 218 are not visible, not accessible, or visible but not visually discernible (for example, the content of the possible longs tab 216 and/or the possible shorts tab 218 not being readable) if the user is not logged in or not registered. In one or more embodiments, the possible longs tab 216 and/or the possible shorts tab 218 are not visible, not accessible, or visible but not visually discernible (for example, the content of the possible longs tab 216 and/or the possible shorts tab 218 not being readable) if the user has not read and/or accepted a risk disclosure.

A longs versus shorts tab 220 shows the number and/or volume of long positions vs the number and/or volume of short positions with respect to a particular asset being scrutinized in the dashboard 210.

An academy tab 222 allows the user to press the tab to show a number of educational and academic content related to trading, including term definitions, market explanations, and/or the like.

FIG. 2-C illustrates an asset price chart 260 generated by a data visualization submodule 242 based on the market data, as discussed below. This market data includes asset prices through time, including in real-time pricing action. The prediction tool module 230, autonomously and without user intervention, analyzes market conditions and correlations to determine or predict trends in the market or markets by applying the trading algorithm to market data. The user does not need to search for or access data sources, such as data sources 160, for the prediction tool 230, through the I/O module 140, to access the market data from the data sources 160. In some embodiments, a user tapping the market strength tab 212 or the asset strength tab 214 causes the application 135 to display a chart such as the chart 260. Via application of the trading algorithm upon the market data, the prediction tool 230 makes pricing predictions 280 in real-time along with upper and lower risk boundaries 270. The farther apart the upper and lower risk boundaries 270, the less certain the probability of the immediate future price for the particular asset, as calculated by the prediction tool 230 using the trading algorithm.

In one or more embodiments, the trading algorithm is a combination of Wycoff Logic and a Clean Order Block or Institutional Candle over an area of liquidity in synchronicity with 90% to 100% Fibonacci retracement, and a convergence or divergence in the MACD or RSI as a double top or bottom, the MACD or RSI being used for a retest of a previous structure (previous support or resistance, for example, the RSI exceeding upper or lower bounds at 80% and 20%). These rules are applied to the Candlestick Chart in the timeframes of 30 years-monthly candles, 20 years-daily candles, 360 days—4 h candles, 360 days—2 h candles, 360 days—1 h candles. When these rules appear on the chart, the system will draw a risk/reward prediction: the risk is drawn from the 50% of the body of the candle to the end of the wick in the order block or the institutional candle. And the reward is drawn in the opposite direction from the 50% of the body of the candle to the next order blocks or institutional candles converging with the same rules, but in the opposite direction.

FIG. 2-D illustrates a block diagram of the user experience module 240 to include a data visualization submodule 242, a community submodule 244, an education submodule 246, and a profit-sharing submodule 248. The data visualization submodule 242 enables the display of data and graphics related to market data or one or more markets. The data visualization submodule 242 receives prediction data from the prediction tool 230 to graphically display the pricing predictions 280 in real-time along with upper and lower risk boundaries 270. The community submodule 244 connects and weights trading ideas from groups of users. The community submodule also handles registration, log-in, and log-out of users. The community submodule also handles communications between users. The education submodule 246 includes courses and learning content for users. The profit-sharing submodule 248 enables outreach from groups of users to other users and non-users.

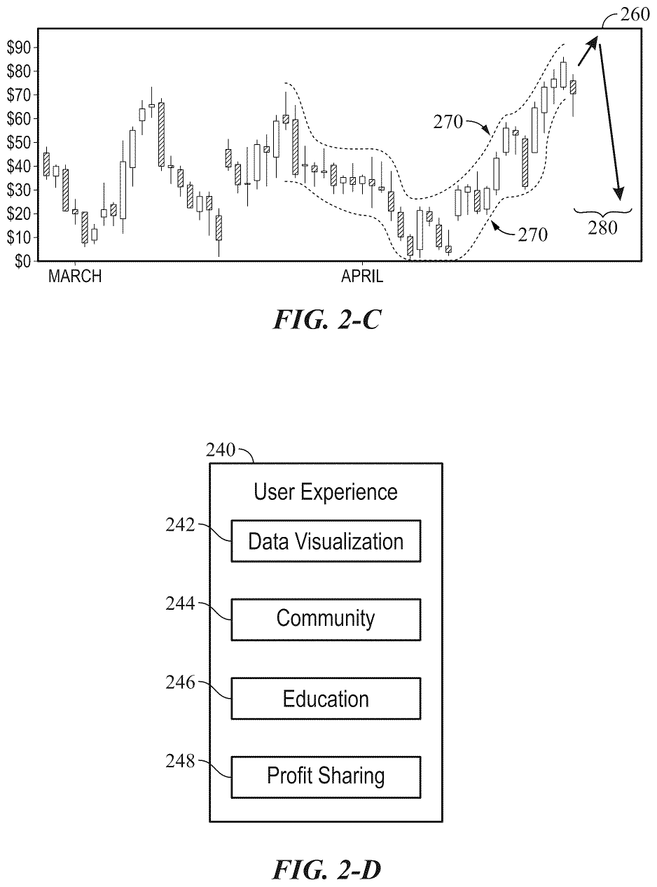

FIG. 3 illustrates a block diagram of prediction tool 230 receiving market data 300 from data sources 160. The data sources 160 includes different systems with different types of data transmitted via different protocols. In one or more embodiments, the data sources 160 include the manual and/or the autonomous transmission of data to the prediction tool 220.

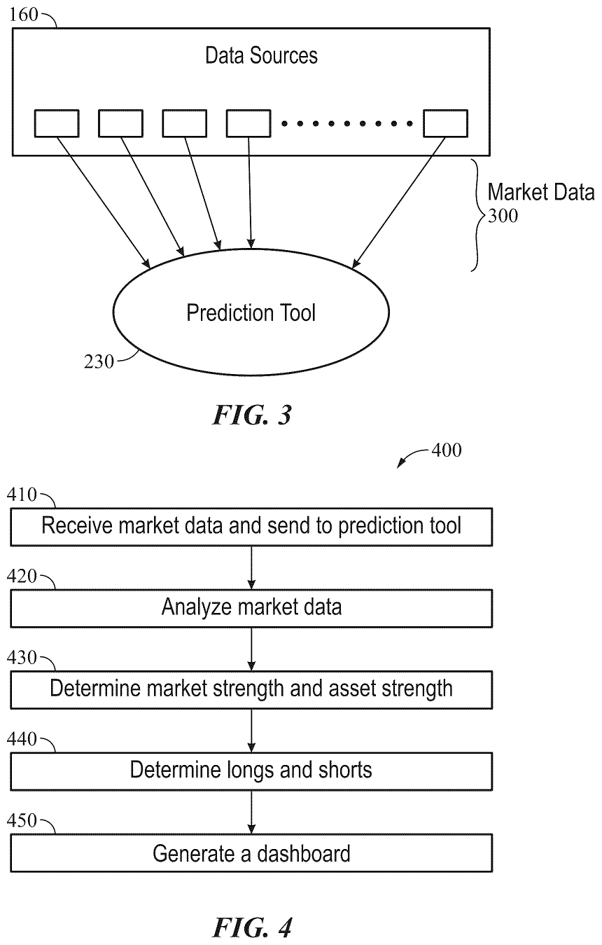

FIG. 4 illustrates a flowchart of process 400 for generating a centralized market data dashboard. The process 400 is executable by and/or in the market data analysis system 100. It will be apparent to those with ordinary skill in the art which types of users (employees, staff, administrators, buyers, sellers, non-users browsing the website of the market data analysis system 100, and so forth) and/or the role of the devices accessing the market data analysis system 100 and/or executing the application 135 or part of the application 135 on devices, the devices then being a computer 100.

The process 400 starts at step 410, where the market data 300 is received and sent to the prediction tool. In one or more embodiments, the market data 300 from one of the plurality of data sources 160 is received and sent automatically to the prediction tool 230. In one or more embodiments, the market data 300 from one of the plurality of data sources 160 is received and sent manually to the prediction tool 230 or inputted manually into the prediction tool 230.

Next, in step 420, the prediction tool 230 analyzes the market data 300. In step 430, the prediction tool 230 determines the market strength and the asset strength based on the market analysis. In step 440, the prediction tool 230 determines longs and shorts. In step 450, the dashboard module 210 and/or the data visualization submodule 242 generate a dashboard displaying the tabs shown in FIG. 2-B and discussed above.

In some embodiments, an active trader dashboard is provided to allow users to track and easily correlate a risk-on and risk-off index, the target asset alongside its negative and positive correlation, past performance and trend in the relative rotation graph, and the cot report. Each correlations COT report dashboard is organized by Risk-on assets, Risk-off assets, currencies, commodities, etc.

In some embodiments, a calendar dashboard allows the user to easily track and correlate how all asset classes are trending based on how the big funds and other relevant market participants are reporting their investments in their official weekly reporting of their positions in the market. The calendar dashboard allows the user to track the Economic calendar, Earnings calendar, Dividend's calendar, IPO calendar, Holiday calendar, and Personal calendar as well so users can track the market and their personal or other business activities from one single screen without having to switch back and forth from different calendars inside and outside of the app.

In some embodiments, a dashboard interface aggregates all indexes by default with a dropdown for other assets/currencies indicating Net Positions and the Trendline. The dashboard view aggregates buying (Gold) vs selling (Blue or Red) volume from all existing forex brokers and dealers for all major currency pairs. A detail view may provide which can be made specific to the major currencies.

In some embodiments, detail views of the dashboard interface are provided to allow for the visualization of individual CoT reports for available assets/currencies, a CoT report chart (Net Positions & Trendline), a graph showing open interest & net positions, bars for longs, shorts, % longs & % shorts, and weekly reports by the numbers.

In some embodiments, a global bond yields by country dashboard is provided which allows the user to easily track and correlate the yield curve for single or multiple countries plotting against each other to help identify relevant trends like the behavior of their yield curve, carry-trades, or where the money is flowing from relevant yields like the 1 month, 3 months, 6 months, 1 year, 2years, 3 years, 5 years, 10 years, 15 years, 40 years.

In some embodiments, a market and product intelligence dashboard is provided which allows the user to easily evaluate, track and correlate the impact of an event relevant to the influence of a product or country on the market.

In some embodiments, a market leaders'dashboard is provided which allows users to easily track and correlate to other assets based on where the money is flowing relevant to which country, sector, industry, company, and product is leading the market.

In some embodiments, rate probability dashboard is provided which allows the user to easily track, correlate, and weigh the monetary policy actions for one or more countries based on the rate probability of each central bank.

In some embodiments, a fundamental dashboard is provided which allows the user to easily track and correlate the Rate probabilities, the Market leaders, the Purchasing Power Parity, the Relative Rotation Graphs, the Trade by Country, and the COT Reports from one single screen and choose which of these are providing more relevant information to the health of the asset(s) they are targeting.

In some embodiments, a relative rotation graphs dashboard is provided which allows the user to easily track and identified the trend or behavior of a single asset based on the behavior and trend of their correlations. The relative rotation graphs allow the users to easily track from one single screen the behavior and trend of all major correlations by regions, countries, industries, currencies, sectors, commodities, etc.

In some embodiments, the application program included an automated price action risk-reward tracker and indicator. The combination and specific use of existing indicators and the specific formula applied to one or more of these indicators is proprietary and particular to our app.

A combination of the Logic, and a Clean Order Block or Institutional Candle over an area of liquidity; in sync with the 90% to 100% Fibonacci retracement, and convergence or divergence in the MACD or RSI as a double top or bottom, a retest of a previous structure (previous support or resistance). These rules are applied to the Candlestick Chart in the timeframes of 30 years-monthly candles, 20 years-daily candles, 360 days-4 h candles, 360 days-2 h candles, and 360 days-1 h candles. When these rules appear on the chart, the system will draw a risk/reward prediction: the risk is drawn from 50% of the body of the institutional candle or order block to the end of the wick or the body of the candle (whatever is greater). And the reward is drawn using the same parameters but in the opposite direction (see the mock-up for the graphical reference of the look and feel of this feature).

In this disclosure, the various embodiments are described with reference to the flowchart illustrations and/or block diagrams of methods, apparatus (systems), and computer program products.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A market analysis system, comprising:
at least one user computing device in operable connection with a user network;
an application server in operable communication with the user network, the application server configured to host an application program for market analysis, the application program including a processor to execute instructions stored in a memory, the processor operable to:
analyze a plurality of market data;
determine, based on the analysis of the plurality of market data, a market strength and an asset strength;
determine, based on the market strength and the asset strength, longs and shorts; and
generate a dashboard displaying on a screen the market strength, the asset strength, the longs, and the shorts.

2. The system of claim 1, wherein the market data is available for analysis without user intervention.

3. The system of claim 1, wherein the asset strength is a currency strength.

4. The system of claim 1, further comprising a prediction tool to autonomously analyze a plurality of market conditions and correlations to determine or predict a market trend.

5. The system of claim 4, wherein the prediction tool applies a trading algorithm to the plurality of market data.

6. The system of claim 5, further comprising a user experience module in operable communication with a data visualization submodule to enable the display of data and graphics related to the plurality of market data or one or more markets.

7. The system of claim 6, wherein the data visualization submodule receives a plurality of prediction data from the prediction tool.

8. The system of claim 7, further comprising a community module to receive a plurality of trading information from one or more third-party users and to assign a value to information provided thereby.

9. The system of claim 8, further comprising an education submodule to provide a plurality of educational content.

10. The system of claim 9, further comprising a profit-sharing submodule to enable the communication between two or more users.

11. A market analysis system, comprising:
at least one user computing device in operable connection with a user network;
an application server in operable communication with the user network, the application server configured to host an application program for market analysis, the application program including a processor to execute instructions stored in a memory, the processor operable to:
analyze, via a prediction tool operating a trading algorithm, a plurality of market data;
determine, based on the analysis of the plurality of market data, a market strength and an asset strength;
determine, based on the market strength and the asset strength analyzed by the prediction tool, one or more longs and one or more shorts; and
generate, via a data visualization submodule, a dashboard displaying on a screen the market strength, the asset strength, the longs, and the shorts.

12. The system of claim 11, wherein the asset strength is a currency strength.

13. The system of claim 12, wherein the prediction tool receives the plurality of market data from one or more data sources to determine the one or more longs and the one or more shorts.

14. The system of claim 13, wherein the prediction tool applies a trading algorithm to the plurality of market data, and wherein the trading algorithm is used via the visualization submodule to display: a risk-on index and a risk-off index; a target asset alongside a negative correlation and a positive correlation; past performance and trend in a relative rotation graph, and a COT report.

15. The system of claim 14, further comprising a user experience module in operable communication with a data visualization submodule to enable the display of data and graphics related to the plurality of market data or one or more markets.

16. The system of claim 15, wherein the data visualization submodule receives a plurality of prediction data from the prediction tool.

17. The system of claim 16, further comprising a community module to receive a plurality of trading information from one or more third-party users and to assign a value to information provided thereby.

18. The system of claim 17, further comprising an education submodule to provide a plurality of educational content.

19. The system of claim 18, further comprising a profit-sharing submodule to enable the communication between two or more users.

20. A method for automating market analysis, the method comprising the steps of:
analyzing a plurality of market data, wherein the market data is available without intervention from a user;
determining market conditions based on the market data;
determining, based on the market conditions, a market strength and an asset strength;
determining, based on the market strength and the asset strength, one or more longs and one or more shorts;
generating, via a display module, a dashboard displayed on a display to illustrate the market strength, the asset strength, the one or more longs, and the one or more shorts. inputting the plurality of assumptions into a financial analysis model operated via a financial model module;
utilizing the financial analysis model to generate a plurality of financial analysis information;
calculating, via a scoring module, a score;
associating the score with the real estate property; and
displaying the score on a property listing interface.
